(19) United States
(12) Patent Application Publication
(10) Pub. No.: US 2022/0364381 A1
(43) Pub. Date: Nov. 17, 2022

(54) METHODS AND SYSTEMS FOR QUANTITATIVE ASSESSMENT OF FLOOD RESILIENCY

(71) Applicant: THE UAB RESEARCH FOUNDATION, Birmingham, AL (US)

(72) Inventor: Rouzbeh Nazari, Birmingham, AL (US)

(21) Appl. No.: 17/744,168

(22) Filed: May 13, 2022

Related U.S. Application Data
(60) Provisional application No. 63/188,247, filed on May 13, 2021.

(51) Int. Cl. E04H 9/14; E02B 3/10; G01W 1/14

(52) U.S. Cl. CPC E04H 9/145; E02B 3/106; G01W 1/14

(57) ABSTRACT

Techniques for a pin-point assessment of resilience and resistance of structures against flooding are disclosed. The model is based on dimensionless analytical functions related to the variation of functionality during a period of interest, including the losses in the disaster and the recovery path. This evolution in time including recovery differentiates the resilience approach from the other approaches addressing the loss estimation and their momentary effects. The recovery process is considered to be dependent on societal preparedness, public policies and can take different forms, which is estimated using recovery functions. Based on the resilience, action plans are created to improve resiliency to disasters.

### CROSS-REFERENCE TO RELATED APPLICATION

This application claims priority to U.S. provisional application entitled, “Methods and Systems for Quantitative Assessment of Flood Resiliency,” having Ser. No. 63/188,247, filed May 13, 2021, which is entirely incorporated herein by reference.

### BACKGROUND

The field of the present disclosure is related to the understanding, quantification, and assessment of flood resiliency and tools to reduce flood damage.

More than 6.6 million homes in the USA, valued at nearly $1.5 trillion, are at risk of storm surge damage. This significant exposure to losses is compounded by expected increases in surge flooding due to sea level rise and climate change.

The catastrophic flooding in the United States after hurricane Sandy in 2012 caused enormous economic damage and human suffering in the states of New York and New Jersey. It is estimated that hurricane Sandy left more than 346,000 homes in New Jersey uninhabitable, damaged, or destroyed and nearly 19,000 businesses sustained damage of $250,000 or more.

It is difficult to determine which actions are helpful in reducing adverse consequences of hurricane disasters. Resources must be used efficiently. Actions are taken by decision makers to apply necessary resilience strategies against disasters. There is a need for quantification of resilience to evaluate and compare effectiveness of preparation and mitigation strategies.

There is ample information about specific mitigation actions, policies, and plans needed to reduce direct or indirect losses from extreme disasters. However, there is not much information about procedures on how to quantify the outcomes of these actions, policies, and plans as a function of recovery time, an important component of resilience.

There is thus a need for a methodology for high resolution resilience quantification of communities exposed to hurricanes and plans for preparation and mitigation to improve the resilience of communities.

### SUMMARY

Defining recovery for an area impacted by a natural disaster, such as flooding, is a difficult problem and relies on many factors not easily quantified. For instance, an area, such as a county, a province, a neighborhood, or even an individual residential or commercial building, may be affected by a natural disaster such as may be caused by a hurricane. A hurricane may be accompanied by high winds and high water, which is very difficult to quantify and causes damage that is dependent upon the ability of an individual building to withstand the wind forces and hydrodynamic forces applied to it. A computing data model is described that not only takes into account the likely forces applied by wind and water on a building, but also takes into account the building characteristics and other environmental factors, an assessment of a building or even an area can be generated that describes the area's resiliency when affected by natural disasters.

Accordingly to some embodiments, a non-transitory computer-readable medium stores instructions that, when executed by a processor, cause the processor to perform actions such as determine an area of interest, determine storm surge modeling data in the area of interest, determine flood modeling data in the area of interest, determine meteorological data in the area of interest, determine topology and structural characteristics of a building in the area of interest, generate a simulation to approximate an expected structural damage of the building, generate a structural resiliency assessment for the building, and display the structural resiliency assessment for the building.

In some cases, structural resiliency can be generated and displayed for many buildings with an area, such as a neighborhood or community where many of the buildings may have similar characteristics and the community itself may have characteristics that affect the resiliency of the community.

According to some embodiments, a computer-implemented method may determine structural characteristics of one or more buildings in a region of interest, conduct stochastic spatial modeling of the one or more buildings in the region of interest, determine wind stochastic data in the region of interest, determine local flood modeling data in the region of interest; generate, based at least in part on the structural characteristics, the spatial modeling, the wind stochastic data, and the local flood modeling data, a structural resiliency assessment of the one or more buildings in the region of interest, and display the structural resiliency assessment of the one or more buildings in the region of interest on a display associated with a computer.

In some cases, the structural characteristics include roof shapes and foundation types of the one or more buildings in the region of interest. The method may include the step of collecting meteorological analysis data in order to determine wind stochastic data. Optionally, flood riverine and coastal modeling data may be used to determine local flood modeling data. Determining the local flood modeling data may require solving time dependent free surface circulation and transport problems in two and three dimensions. The local flood modeling data may further require gathering bathymetry, topography, tidal characteristics, nodal attributes, meteorological forcing input, boundary information, river inflow, and wave radiation stress forcing data.

In some embodiments, generating the structural resiliency assessment may further include generating a two-dimensional hydrodynamic model, which may be specific to individual buildings. In some instances, the structural resiliency assessment is based on local flood modeling data in combination with spatial modeling data on individual buildings.

The result is a resiliency assessment that provides a resiliency index that takes into account wind, water, building characteristics, and provides a damage assessment and likely time for an affected area to recover. Based on the resiliency assessment, action plans can be created and implemented to improve an areas resiliency index.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 shows a flowchart of incorporating data into a damage model and generating a resiliency determination, in accordance with some embodiments.

FIG. 2 shows a flow diagram for hydrodynamic modeling and damage assessment, in accordance with some embodiments.

FIG. 3 shows a recovery curve for different damage levels based on community preparedness conditions; in accordance with some embodiments.

FIG. 4 shows a distribution of recovery time; according to some embodiments.

FIG. 5 shows a flowchart for generating and displaying a structural resiliency assessment according to some embodiments.

FIG. 6 is a block diagram illustrating an exemplary computing system or device that can be utilized for systems and methods of the present disclosure.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

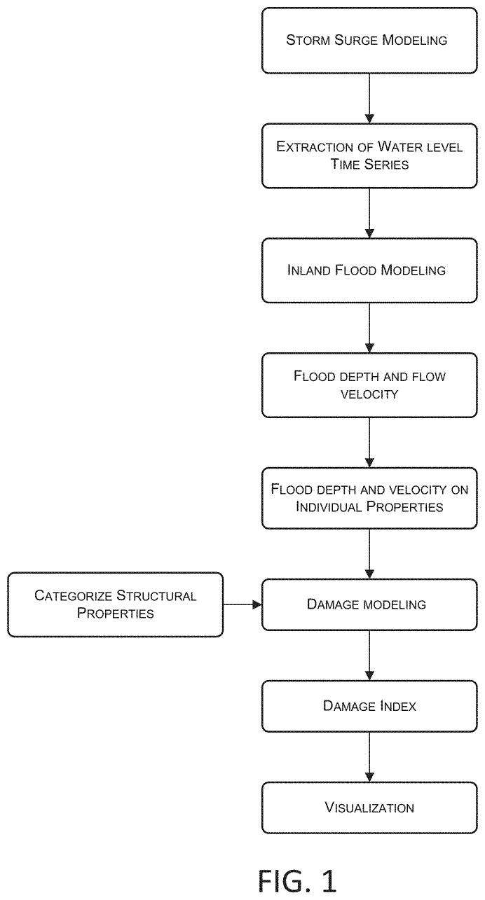

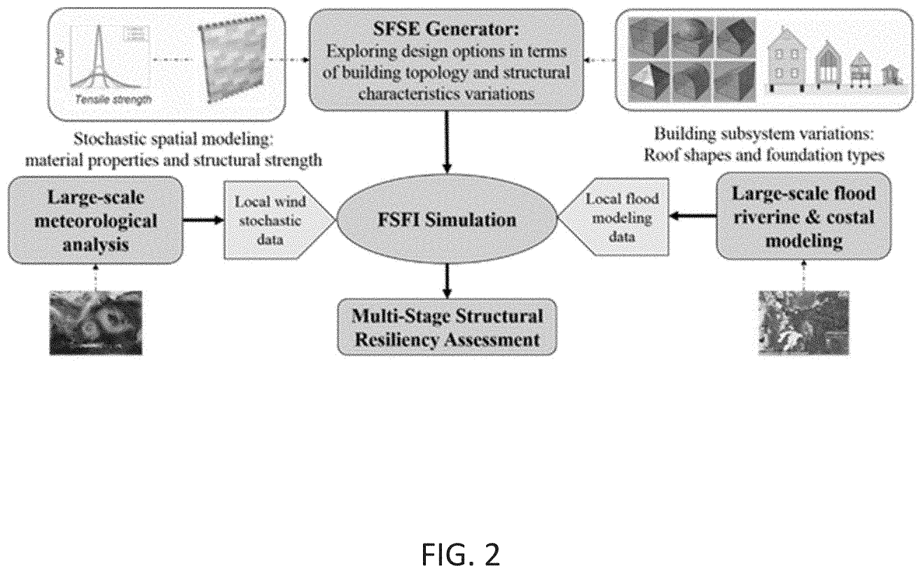

With reference to FIGS. 1 and 2, the process of structural vulnerability assessment related to flooding can be divided into three main components. First, developing a storm surge model to generate storm surge due to extreme storm events (e.g., hurricanes), such as by using software for solving time dependent, free surface circulation and transport problems in two and three dimensions, such as ADCIRC.

The storm surge model may further require information such as, but not limited to, bathymetry, topography, tidal characteristics, nodal attributes, meteorological forcing input, boundary information, river inflow, wave radiation stress forcing, among other relevant information.

A two-dimensional hydrodynamic model may be generated to simulate the dynamic effect of flooding on individual properties, such as residential and commercial properties.

Third, a structural damage assessment model may be generated by combining the flooding information with specific property information.

Defining recovery is difficult since the recovery process is (very) complex and has various associated dimensions. For instance, recovery of a poor neighborhood from a disaster is usually slower compared to that of a rich neighborhood, as expected. Currently, there is no suggested representation for recovery from hurricanes. Earthquake studies have been suggested and recovery functions related to earthquake recovery may be used for all damage states. However, if flood momentum is not too high, there may be only minor or moderate damage, and recovery can be very fast. If flood momentum is very high, there may be severe damage or destruction, and recovery can be relatively slow. Assignment of separate recovery functions to different communities (i.e. poor, fair, and good condition) may provide more accurate resiliency estimates. The recovery function is based on the response of the affected system/society and includes the following linear combination of exponential and trigonometric recovery functions shown in Equation 1 below.

f_{rec}(t)=a(a exp[−b(t−t_{0E})]/T_{RE})+(1−a)(a/2){1+cos[πb(t−t_{0E})]/T_{RE}} Equation 1

According to Equation 1, shown above, a and b are constant values that are calculated using curve fitting to the available data sources. Parameter a represents the level of society preparedness in face of hurricane. The value t_{0E} is the instance of time when the extreme hurricane strikes and can be assigned to zero. T_{RE} is the recovery time necessary to go back to pre-disaster condition evaluated starting from t_{0E}. The exponential recovery part is found to be suitable when the initial response was fast because of the high level of resources and preparedness, and it slowed down later. The trigonometric recovery component is considered when the response is initially slow due to the lack of resources and preparedness, and it improved over time.

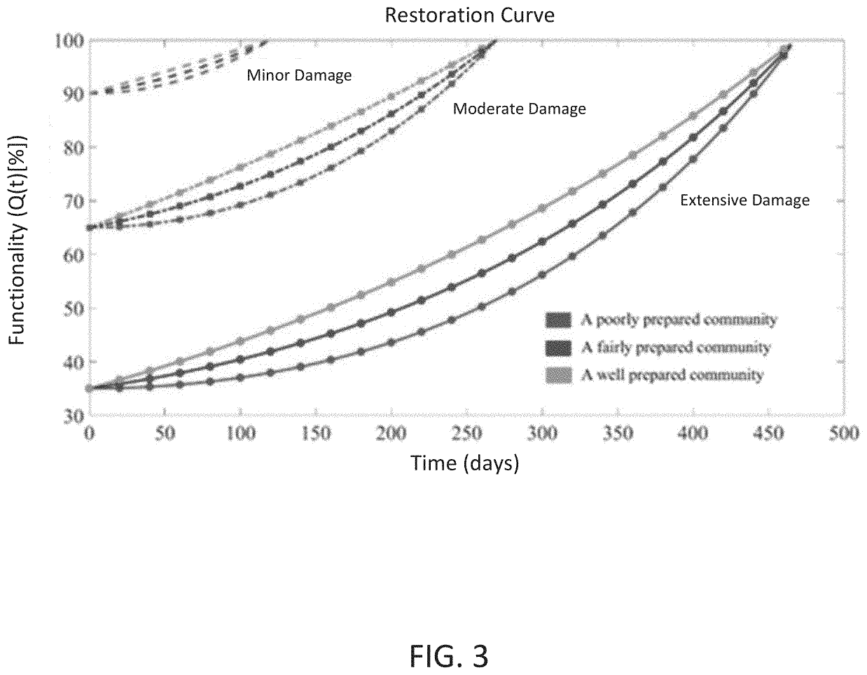

FIG. 3 shows a graphical interpretation of the resilience of a community. Notably, accurate estimation of T_{RE} is critical to quantify resilience. In order to estimate recovery time, the calculation of loss of use approach from the hurricane module of HAZUS for residential buildings may be used. HAZUS is a geographic information system-based natural hazard analysis tool that has been developed and distributed by the Federal Emergency Management Agency (“FEMA”). Five damage states, namely no damage, slight damage, moderate damage, extensive damage, and complete damage, correspond to damages of 0, 2, 10, 50, and 100 percent, respectively. In the present model, losses of use for these five damage states are given as 0, 5, 120, 360, and 720 days, respectively. A linear interpolation is used to compute expected recovery times for loss ratios different from these five cases.

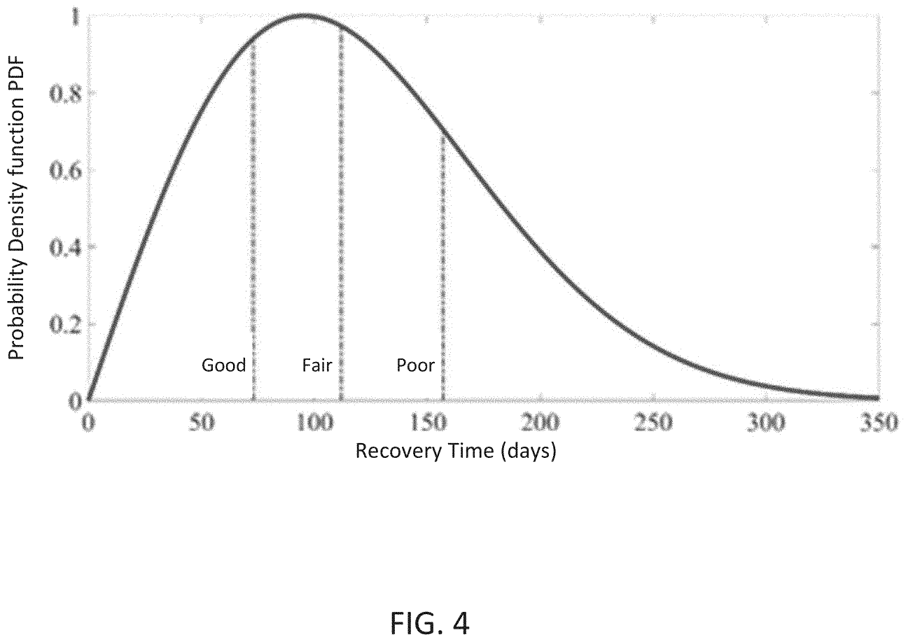

FIG. 4 shows a Rayleigh distribution recovery time with mean values of 120 days for moderate damages, (e.g., DI=10%). As illustrated, the vertical lines indicate the first, second, and third quartiles of the curve and represent the estimated recovery time for different preparedness levels. For example, a community with “good” preparedness, may recover in about 73 days. A community with “fair” preparedness may average 100 days to recover. Finally, a community with poor preparedness may average 157 days to recover.

Actual recovery times may also be used for damage states. The actual recovery time can be less than, equal to, or greater than the expected recovery time for each damage state. Actual recovery times for minor damage, moderate damage, severe damage, and destruction can be calculated assuming it follows Rayleigh distribution with mean values of 5, 120, 360, and 720, respectively.

The quantification of resilience is strictly connected to the quantification of functionality (or quality or serviceability) of the system, in time. After the occurrence of an extreme event, that can be flooding in this case, the investigated structural system loses some of its functionality owing to occurrence of flood damages. Consequently, after receiving repair actions, the total functionality of the building can be restored at time T_{RE}. Therefore, the area above the recovery curve in FIG. 3 represents the resilience loss R_{L} and eventually the resilience index RI can be calculated by Equation 2 below.

$$RI = 0 \leq \frac{{\int }_{{t}_{0}}^{{t}_{0} + {T}_{RE}} Q ( t ) dt}{{T}_{RE}} \leq 1 \qquad Equation 2$$

Equation 2, shown above, is a measure of Resilience index and has the merit of combining all the dimensions, properties, and results of resilience in a single scalar metric defined over the interval [0,1].

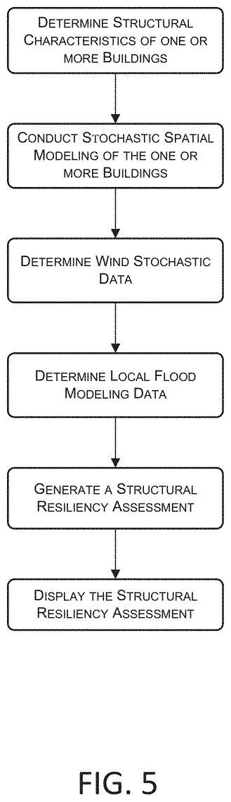

FIG. 5 shows a flowchart for generating and displaying a structural resiliency assessment according to some embodiments. In various embodiments, an exemplary method comprises steps involving determining structural characteristics of one or more buildings; conducting stochastic spatial modeling of the one or more buildings; determining wind stochastic data; determining local flood modeling data; generating a structural resiliency assessment; and/or displaying the structural resiliency assessment.

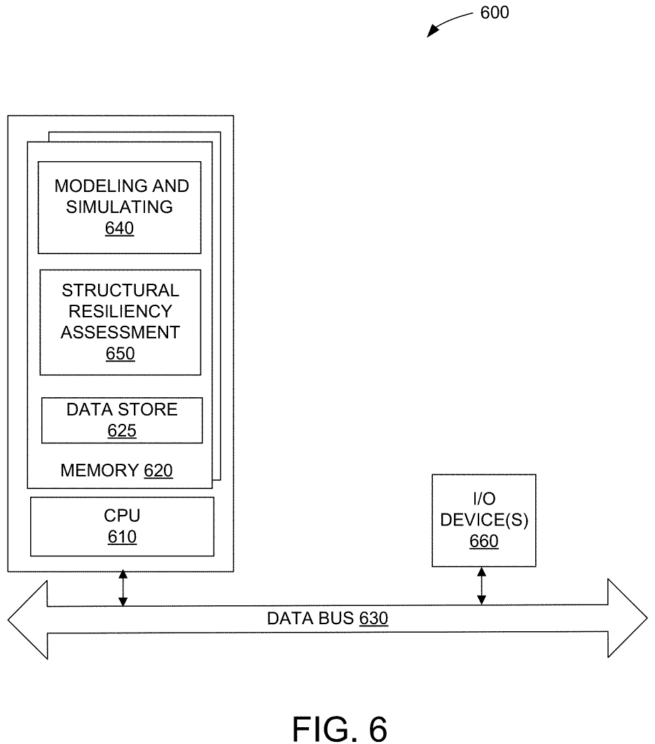

FIG. 6 is a block diagram illustrating an exemplary computing system or device 600 that can be utilized for systems and methods of the present disclosure. Computing system 600 includes at least one processor, e.g., a central processing unit (CPU), 610 coupled to memory elements 620 through a data bus 630 or other suitable circuitry. Computing system 600 stores program code within memory elements 620. Processor 610 executes the program code accessed from memory elements 620 via the data bus 630. In one aspect, computing system 600 may be implemented as a computer or other data processing system, including tablets, smartphones, or server computers that are accessed using browsers at client computers. It should be appreciated, however, that computing system 600 can be implemented in the form of any system including a processor and memory that is capable of performing the functions described within this disclosure.

Memory elements 620 include one or more physical memory devices such as, for example, a local memory and one or more storage devices. Local memory refers to random access memory (RAM) or other non-persistent memory device(s) generally used during actual execution of the program code. Storage device may be implemented as a hard disk drive (HDD), solid state drive (SSD), or other persistent data storage device. Computing system 600 may also include one or more cache memories (not shown) that provide temporary storage of at least some program code in order to reduce the number of times program code must be retrieved from storage device during execution.

Stored in the memory 620 are both data and several components that are executable by the processor 610. In particular, stored in the memory 620 and executable by the processor 610 are code for modeling and simulating an expected structural damage of a building (640) and code for generating a structural resiliency assessment (650) for the building. Also stored in the memory 620 may be a data store 625 and other data. The data store 625 can include an electronic repository or database relevant to modeling and simulation results. In addition, an operating system may be stored in the memory 620 and executable by the processor 610. In an embodiment, model data are stored in the data store 625, such as model parameters.

For example, a computer data model of the present disclosure may refer to an electronic digitally stored set of executable instructions and data values, associated with one another, which are capable of receiving and responding to a programmatic or other digital call, invocation, or request for resolution based upon specified input values, to yield one or more stored output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

Input/output (I/O) devices 660 such as a keyboard, a display device, and a pointing device may optionally be coupled to computing system 600. The I/O devices may be coupled to computing system 600 either directly or through intervening I/O controllers. A network adapter may also be coupled to computing system to enable computing system to become coupled to other systems, computer systems, remote printers, and/or remote storage devices through intervening private or public networks. Modems, cable modems, Ethernet cards, and wireless transceivers are examples of different types of network adapter that may be used with computing system 600.

The described methods may be used as routines, or instructions, that cause a computer to perform various acts. Some of these acts include retrieving information necessary to perform a structural resiliency assessment. Referring back to FIG. 1, as an example, an exemplary method for incorporating data into a damage model and generating a resiliency determination comprises operations involving storm surge modeling; extraction of water level time series; inland flood modeling; flood depth and flow velocity; flood depth and velocity on individual properties; damage modeling based on categorizing structural properties; damage index; and/or visualization.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein. The system and related methods may well be described in the general context of computer-executable instructions, such as program modules, being executed by a computer. Generally, program modules include routines, programs, objects, components, data structures, etc. that perform particular tasks or implement particular abstract data types or equations for a useful, transformative, and physical purpose. The embodiments may be practiced in distributed computing environments where tasks are performed by remote processing devices that are linked through a communications network.

As used herein, the term “or” is used inclusively to refer items in the alternative and in combination.

Embodiments of the present disclosure have been shown and described as set forth herein and are provided by way of example only. One of ordinary skill in the art will recognize numerous adaptations, changes, variations, and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

1. A non-transitory computer-readable medium storing instructions that, when executed by a processor, cause the processor to perform actions comprising:
determine an area of interest;
determine storm surge modeling data in the area of interest;
determine flood modeling data in the area of interest;
determine meteorological data in the area of interest;
determine topology and structural characteristics of a building in the area of interest;
generate, based upon the storm surge modeling data, the flood modeling data, the meteorological data, and the topology and structural characteristics, a computer simulation that approximates an expected structural damage of the building;
generate a structural resiliency assessment for the building; and
display the structural resiliency assessment for the building.

2. The non-transitory computer-readable medium of claim 1, wherein the instructions cause the processor to generate and display the structural resiliency assessment for a plurality of buildings within the area of interest.

3. A computer-implemented method, comprising:
determine structural characteristics of one or more buildings in a region of interest;
conduct stochastic spatial modeling of the one or more buildings in the region of interest;
determine wind stochastic data in the region of interest;
determine local flood modeling data in the region of interest;
generate, based at least in part on the structural characteristics, the spatial modeling, the wind stochastic data, and the local flood modeling data, a structural resiliency assessment of the one or more buildings in the region of interest; and
display the structural resiliency assessment of the one or more buildings in the region of interest on a display associated with a computer.

4. The computer implemented method of claim 3, wherein determine the structural characteristics comprises determining roof shapes and foundation types of the one or more buildings in the region of interest.

5. The computer-implemented method of claim 3, wherein determine wind stochastic data comprises collecting meteorological analysis data.

6. The computer-implemented method of claim 3, wherein determine local flood modeling data comprises determining flood riverine and coastal modeling data.

7. The computer-implemented method of claim 3, wherein determine local flood modeling data further comprises solving time dependent free surface circulation and transport problems in two and three dimensions.

8. The computer-implemented method of claim 7, wherein determine local flood modeling data further comprises gathering bathymetry, topography, tidal characteristics, nodal attributes, meteorological forcing input, boundary information, river inflow, and wave radiation stress forcing data.

9. The computer-implemented method of claim 3, wherein generate the structural resiliency assessment further comprises generating a two-dimensional hydrodynamic model.

10. The computer-implemented method of claim 9, further comprising generating the two-dimensional hydrodynamic model on individual buildings within the region of interest.

11. The computer-implemented method of claim 3, wherein generate the structural resiliency assessment is based at least in part on the local flood modeling data and spatial modeling data on individual buildings.

12. The computer-implemented method of claim 3, wherein generate the structural resiliency assessment comprises solving a recovery function of the form
f_{rec}(t)=a(a exp[−b(t−t_{0E})]/T_{RE})+(1−a)(a/2){1+cos[πb(t−t_{0E})]/T_{RE}}

13. The computer-implemented method of claim 3, further comprising generate a resiliency index for the region of interest.

14. The computer-implemented method of claim 13, wherein the resiliency index is generated according to the form
$$RI = 0 \leq \frac{{\int }_{{t}_{0}}^{{t}_{0} + {T}_{RE}} Q ( t ) dt}{{T}_{RE}} \leq 1.$$
